(19) United States
(12) Patent Application Publication
(10) Pub. No.: US 2015/0066630 A1
(43) Pub. Date: Mar. 5, 2015

(54) CONTENT SELECTION WITH PRECISION CONTROLS

(71) Applicant: Google Inc., Mountain View, CA (US)

(72) Inventors: Rong Ge, Mountain View, CA (US); Yong Sheng, Mountain View, CA (US); Arthur Asuncion, Mountain View, CA (US); Jonathan Michael Krafcik, Mountain View, CA (US); Yiming Li, Beijing (CN)

(73) Assignee: Google Inc., Mountain View, CA (US)

(21) Appl. No.: 14/105,762

(22) Filed: Dec. 13, 2013

Related U.S. Application Data
(63) Continuation of application No. PCT/CN2013/082620, filed on Aug. 30, 2013.

(51) Int. Cl. G06Q 30/02

(52) U.S. Cl. CPC G06Q 30/0244
USPC 705/14.43

(57) ABSTRACT

Systems and methods for content selection with precision controls include receiving a content selection parameter value and a degree of precision specified by a content provider. A content selection parameter value for a device identifier may be predicted using a predictive model. A precision factor may be associated with the predicted content selection parameter value. Content from the provider may be selected based on a comparison between the predicted selection parameter value and precision factor for the device identifier and the selection parameter value and degree of precision specified by the content provider.

### CROSS-REFERENCE TO RELATED PATENT APPLICATIONS

This application is a continuation of International Application number PCT/CN2013/082620, filed Aug. 30, 2013, which is incorporated by reference herein in its entirety.

### BACKGROUND

Online content may be received from various first-party or third-party sources. In general, first-party content refers to the primary online content requested or displayed by a user's device. For example, first-party content may be a webpage requested by the client or a stand-alone application (e.g., a video game, a chat program, etc.) running on the device. Third-party content, in contrast, refers to additional content that may be provided in conjunction with the first-party content. For example, third-party content may be a public service announcement or advertisement that appears in conjunction with a requested webpage (e.g., a search result webpage from a search engine, a webpage that includes an online article, a webpage of a social networking service, etc.) or within a stand-alone application (e.g., an advertisement within a game). More generally, a first-party content provider may be any content provider that allows another content provider (i.e., a third-party content provider) to provide content in conjunction with that of the first-party content provider.

### SUMMARY

Implementations of the systems and methods for content selection with precision controls are disclosed herein. One implementation is a method of selecting content for presentation by a device. The method includes generating, by one or more processors, a predictive model that estimates values of a content selection parameter based on online actions associated with a set of device identifiers. The method also includes receiving, at the one or more processors, data indicative of online actions associated with a device identifier representing the device. The method further includes determining, by the one or more processors, a predicted value of the content selection parameter for the device identifier using the predictive model and the data indicative of online actions associated with the device identifier. The method also includes determining, by the one or more processors, a precision factor associated with the predicted value of the content selection parameter for the device identifier. The method additionally includes receiving a value and a degree of precision for the content selection parameter that are specified by a content provider. The method yet further includes selecting content of the content provider for presentation by the device based in part on a comparison between the predicted value and the value of the content selection parameter specified by the content provider and based in part on a comparison between the precision factor associated with the predicted value and the degree of precision specified by the content provider.

Another implementation is a system for selecting content for presentation by a device. The system includes one or more processors configured to generate a predictive model that estimates values of a content selection parameter based on online actions associated with a set of device identifiers. The one or more processors are also configured to receive data indicative of online actions associated with a device identifier representing the device. The one or more processors are additionally configured to determine a predicted value of the content selection parameter for the device identifier using the predictive model and the data indicative of online actions associated with the device identifier. The one or more processors are yet further configured to determine a precision factor associated with the predicted value of the content selection parameter for the device identifier. The one or more processors are also configured to receive a value and a degree of precision for the content selection parameter that are specified by a content provider. The one or more processors are additionally configured to select content of the content provider for presentation by the device based in part on a comparison between the predicted value and the value of the content selection parameter specified by the content provider and based in part on a comparison between the precision factor associated with the predicted value and the degree of precision specified by the content provider.

A further implementation is a computer-readable storage medium having machine instructions stored therein, the instructions being executable by a processor to cause the processor to perform operations. The operations include generating a predictive model that estimates values of a content selection parameter based on online actions associated with a set of device identifiers. The operations also include receiving data indicative of online actions associated with a device identifier representing the device. The operations further include determining a predicted value of the content selection parameter for the device identifier using the predictive model and the data indicative of online actions associated with the device identifier. The operations also include determining a precision factor associated with the predicted value of the content selection parameter for the device identifier. The operations yet further include receiving a value and a degree of precision for the content selection parameter that are specified by a content provider. The operations also include selecting content of the content provider for presentation by the device based in part on a comparison between the predicted value and the value of the content selection parameter specified by the content provider and based in part on a comparison between the precision factor associated with the predicted value and the degree of precision specified by the content provider.

These implementations are mentioned not to limit or define the scope of the disclosure, but to provide an example of an implementation of the disclosure to aid in understanding thereof. Particular implementations may be developed to realize one or more of the following advantages.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of an implementation of a computer system in which third-party content is selected for presentation with first-party content;

FIG. 2 is an illustration of one implementation of an electronic display showing a first-party webpage with embedded third-party content;

FIG. 3 is a flow diagram of the steps taken in one implementation of a process for selecting third-party content using precision controls;

FIG. 4 is an illustration of one implementation of a model generated to predict content selection parameters;

FIG. 5 is an illustration of one implementation of the predictive model of FIG. 4 used to predict content selection parameters for a device identifier;

FIG. 6 is a block diagram of one implementation of the content selection service of FIG. 1; and

FIG. 7 is an illustration of one implementation of an interface configured to allow a third-party content provider to specify content selection parameters with precision controls.

Like reference numbers and designations in the various drawings indicate like elements.

### DETAILED DESCRIPTION

According to various aspects of the present disclosure, a first-party content provider may allow a content selection service to determine which third-party content is to be provided in conjunction with the first-party provider's content. In exchange for doing so, the first-party content provider may receive a portion of any revenues collected by the content selection service from third-party content providers. For example, a website operator may allow third-party advertisements to be selected by a content selection service for placement on the pages of the website. In turn, the content selection service may charge the third-party content providers that place content on the website a certain amount and apportion a percentage of this amount to the first-party content provider.

A content selection service may be configured to base the selection of third-party content on any number of content selection parameters specified by a third-party content provider. For example, a third-party advertiser may use content selection parameters to control which devices receive advertisements from the advertiser. Content selection parameters may be of any type, such as parameters that control the types of devices eligible to receive the third-party content (e.g., based on whether the device is a desktop device, mobile device, tablet device, etc.) or the configuration of the devices (e.g., based on a device's operating system, hardware configuration, etc.). Further content selection parameters may control with which first-party content the third-party content may be presented. For example, some content selection parameters may correspond to search keywords (e.g., if the third-party content is to be presented with search results), topical categories (e.g., if the third-party content is to be presented on first-party websites or in first-party applications), or other characteristics of the first-party content. In some cases, a third-party content provider may even be able to specify specific first-party websites or applications with which the third-party content may be presented.

A content selection service may be configured to allow the use of content selection parameters corresponding to characteristics of a user (e.g., information about a user's social network, social actions or activities, a user's preferences, a user's current location, a user's demographics, etc.). In such cases, the system may take additional steps to ensure the privacy of the user. For example, the user may be provided with an opportunity to control which programs or features collect information about the user, the types of information that may be collected, and/or how third-party content may be selected by the content selection service and presented to the user. Certain data, such as a device identifier, may be anonymized in one or more ways before it is stored or used, so that personally identifiable information is removed when generating content selection parameters used by the content selection service to select third-party content. For example, a device identifier may be anonymized so that no personally identifiable information about its corresponding user can be determined by the content selection service from it. In another example, a user's geographic location may be generalized where location information is obtained (such as to a city, ZIP code, or state level), so that a precise location of the user cannot be determined. Thus, the user of a device may have control over how information is collected about him or her and used by the content selection service.

A content selection service may predict content selection parameter values regarding a user, while still taking measures that ensure the privacy of the user. In other words, a content selection service may not use personally identifiable information about the user, but may still attempt to estimate characteristics of the user to control which content is selected for presentation by the user's device. For example, the content selection service may use selection parameter values corresponding to a user's estimated age or gender to control which third-party content is eligible to be selected for presentation by the device of the user. In some cases, the service may be configured to combine different parameters into a single content selection parameter. For example, the content selection service may use a content selection parameter that has a value corresponding to a combination of a predicted age and gender. In some implementations, the content selection service may also determine precision factors associated with any predicted content selection parameter values. The precision factors may represent a degree of confidence in the predicted content selection parameter values. For example, an estimated content selection parameter value may have an associated precision of 80%, indicating an 80% chance that the actual characteristic of the user matches the estimated value of the content selection parameter.

In some implementations, a content selection service may be configured to allow a third-party content provider to specify a precision factor when using a content selection parameter. For example, a third-party content provider may specify a content selection parameter value corresponding to an age range of 24-34 and/or a gender of female with a precision of 85%. As the degree of precision increases, the pool of devices eligible to receive content from the provider decreases. Conversely, lowering the degree of precision increases the potential audience for the provider's content. Thus, different third-party content providers may use different precision factors for the same content selection parameter value, depending on the goals of the provider.

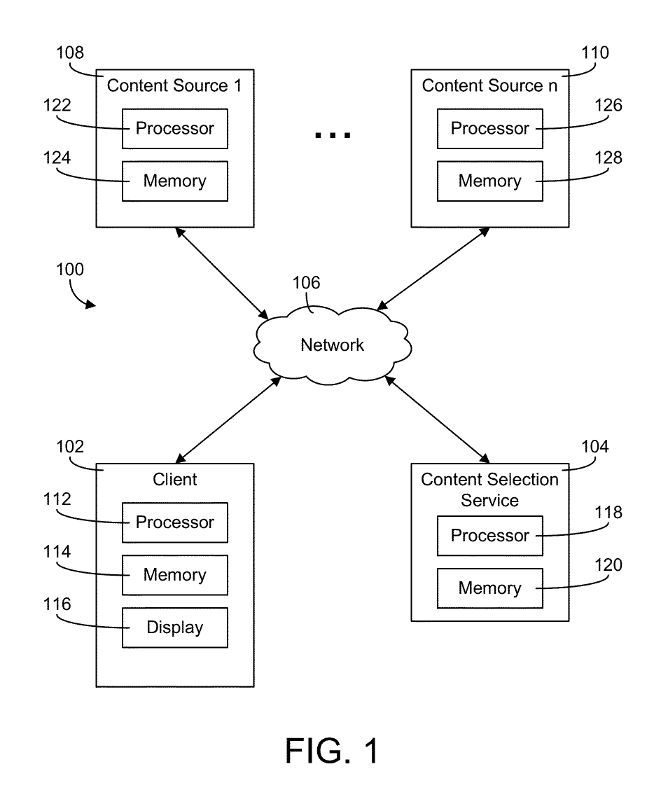

Referring to FIG. 1, a block diagram of a computer system 100 in accordance with a described implementation is shown. System 100 includes a client device 102 which communicates with other computing devices via a network 106. Client device 102 may execute a web browser or other application (e.g., a video game, a messenger program, a media player, a social networking application, etc.) to retrieve content from other devices over network 106. For example, client device 102 may communicate with any number of content sources 108, 110 (e.g., a first content source through nth content source). Content sources 108, 110 may provide webpage data and/or other content, such as images, video, and audio, to client device 102. Computer system 100 may also include a content selection service 104 configured to select third-party content to be provided to client device 102. For example, content source 108 may provide a first-party webpage to client device 102 that includes additional third-party content selected by content selection service 104.

Network 106 may be any form of computer network that relays information between client device 102, content sources 108, 110, and content selection service 104. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client device 102 may communicate wirelessly (e.g., via WiFi, cellular, radio, etc.) with a transceiver that is hardwired (e.g., via a fiber optic cable, a CATS cable, etc.) to other computing devices in network 106.

Client device 102 may be any number of different types of user electronic devices configured to communicate via network 106 (e.g., a laptop computer, a desktop computer, a tablet computer, a smartphone, a digital video recorder, a set-top box for a television, a video game console, combinations thereof, etc.). In some implementations, the type of client device 102 may be categorized as being a mobile device, a desktop device (e.g., a device intended to remain stationary or configured to primarily access network 106 via a local area network), or another category of electronic devices (e.g., tablet devices may be a third category, etc.). Client device 102 is shown to include a processor 112 and a memory 114. Memory 114 may store machine instructions that, when executed by processor 112 cause processor 112 to perform one or more of the operations described herein. Processor 112 may include a microprocessor, ASIC, FPGA, etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ROM, RAM, EEPROM, EPROM, flash memory, optical media, or any other suitable memory from which processor 112 can read instructions. The instructions may include code from any suitable computer programming language.

Client device 102 may include one or more user interface devices. A user interface device may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). The one or more user interface devices may be internal to the housing of client device 102 (e.g., a built-in display, microphone, etc.) or external to the housing of client device 102 (e.g., a monitor connected to client device 102, a speaker connected to client device 102, etc.), according to various implementations. For example, client device 102 may include an electronic display 116, which displays webpages and other data received from content sources 108, 110 and/or content selection service 104. In various implementations, display 116 may be located inside or outside of the same housing as that of processor 112 and/or memory 114. For example, display 116 may be an external display, such as a computer monitor, television set, or any other stand-alone form of electronic display. In other examples, display 116 may be integrated into the housing of a laptop computer, mobile device, or other form of computing device having an integrated display.

Content sources 108, 110 may be one or more electronic devices connected to network 106 that provide content to devices connected to network 106. For example, content sources 108, 110 may be computer servers (e.g., FTP servers, file sharing servers, web servers, etc.) or combinations of servers (e.g., data centers, cloud computing platforms, etc.). Content may include, but is not limited to, webpage data, media files, search results, other forms of electronic documents, and applications executable by client device 102. For example, content source 108 may be an online search engine that provides search result data to client device 102 in response to a search query. In another example, content source 110 may be a first-party web server that provides webpage data to client device 102 in response to a request for the webpage. Similar to client device 102, content sources 108, 110 may include processors 122, 126 and memories 124, 128, respectively, that store program instructions executable by processors 122, 126. For example, the processing circuit of content source 108 may include instructions such as web server software, FTP serving software, and other types of software that cause content source 108 to provide content via network 106.

According to various implementations, content sources 108, 110 may provide first-party webpage data to client device 102 that includes one or more content tags. In general, a content tag refers to any piece of webpage code associated with the action of including third-party content with a first-party webpage. For example, a content tag may define a slot on a webpage for third-party content, a slot for out of page third-party content (e.g., an interstitial slot), whether third-party content should be loaded asynchronously or synchronously, whether the loading of third-party content should be disabled on the webpage, whether third-party content that loaded unsuccessfully should be refreshed, the network location of a content source that provides the third-party content (e.g., content sources 108, 110, content selection service 104, etc.), a network location (e.g., a URL) associated with clicking on the third-party content, how the third-party content is to be rendered on a display, a command that causes client device 102 to set a browser cookie (e.g., via a pixel tag that sets a cookie via an image request), one or more keywords used to retrieve the third-party content, and other functions associated with providing third-party content with a first-party webpage. For example, content source 108 may serve first-party webpage data to client device 102 that causes client device 102 to retrieve third-party content from content selection service 104. In another implementation, content may be selected by content selection service 104 and provided by content source 108 as part of the first-party webpage data sent to client device 102. In a further example, content selection service 104 may cause client device 102 to retrieve third-party content from a specified location, such as memory 114 or content sources 108, 110.

Content selection service 104 may also be one or more electronic devices connected to network 106. Content selection service 104 may be a computer server (e.g., FTP servers, file sharing servers, web servers, etc.) or a combination of servers (e.g., a data center, a cloud computing platform, etc.). Content selection service 104 may include a processor 118 and a memory 120 that stores program instructions executable by processor 118. In cases in which content selection service 104 is a combination of computing devices, processor 118 may represent the collective processors of the devices and memory 120 may represent the collective memories of the devices.

Content selection service 104 may be configured to select third-party content for presentation by client device 102. In one implementation, the selected third-party content may be provided by content selection service 104 to client device 102 via network 106. For example, content source 110 may upload the third-party content to content selection service 104. Content selection service 104 may then provide the third-party content to client device 102 to be presented in conjunction with first-party content provided by content source 108. In other implementations, content selection service 104 may provide an instruction to client device 102 that causes client device 102 to retrieve the selected third-party content (e.g., from memory 114 of client device 102, from content source 110, etc.). For example, content selection service 104 may select third-party content to be provided as part of a first-party webpage being visited by client device 102 or within a first-party application being executed by client device 102 (e.g., within a game, messenger application, etc.).

In some implementations, content selection service 104 may be configured to select content based on data associated with a device identifier for client device 102. In general, a device identifier refers to any form of data that may be used to represent a device or software that receives content selected by content selection service 104. In some implementations, a device identifier may be associated with one or more other device identifiers (e.g., a device identifier for a mobile device, a device identifier for a home computer, etc.). Device identifiers may include, but are not limited to, cookies, device serial numbers, user profile data, or network addresses. For example, a cookie set on client device 102 may be used to identify client device 102 to content selection service 104. Content selection service 104 may use any form of data associated with the device identifier for client device 102 as content selection parameter values that control which types of content are eligible for presentation by client device 102. For example, data associated with the device identifier may indicate the type of device, configuration of the device, or any other such information that can be used to control whether client device 102 is eligible to receive certain third-party content.

Content selection service 104 may use predicted user characteristics to select third-party content that is likely to be relevant to the user of client device 102. In some implementations, data associated with a device identifier for client device 102 may be used by content selection service 104 to predict characteristics of the user of client device 102. Content selection service 104 may also be configured to protect the user's privacy by allowing the user of client device 102 to control what types of information about the user may be collected by content selection service 104, how content selection service 104 uses the information, and/or how content selection service 104 selects third-party content for presentation by client device 102. The device identifier for client device 102 may also be anonymized by content selection service 104 such that personally identifiable information about the user of client device 102 cannot be determined by analyzing the device identifier representing client device 102.

In one implementation, content selection service 104 may receive data indicative of online actions associated with a device identifier. In implementations in which a content tag causes client device 102 to request content from content selection service 104, such a request may include a device identifier for client device 102 and/or additional information (e.g., the webpage being loaded, the referring webpage, etc.). For example, content selection service 104 may receive and store history data regarding whether or not third-party content provided to client device 102 was selected using an interface device (e.g., the user of client device 102 clicked on a third-party hyperlink, third-party image, etc.). Content selection service 104 may store such data to record a history of online events associated with a device identifier. In some cases, client device 102 may provide history data to content selection service 104 without first executing a content tag. For example, client device 102 may periodically send history data to content selection service 104 or may do so in response to receiving a command from a user interface device. In some implementations, content selection service 104 may receive history data from content sources 108, 110. For example, content source 108 may store history data regarding web transactions with client device 102 and provide the history data to content selection service 104.

Content selection service 104 may analyze data indicative of online actions to identify one or more topics that may be of interest to the user of client device 102. For example, content selection service 104 may perform text and/or image analysis on a webpage from content source 108, to determine one or more topics of the webpage. In some implementations, a topic may correspond to a predefined interest category used by content selection service 104. For example, a webpage devoted to the topic of golf may be classified under the interest category of sports. In some cases, interest categories used by content selection service 104 may conform to a taxonomy (e.g., an interest category may be classified as falling under a broader interest category). For example, the interest category of golf may be /Sports/Golf, /Sports/Individual Sports/Golf, or under any other hierarchical category. Similarly, content selection service 104 may analyze the content of a first-party webpage accessed by client device 102 to identify one or more topical categories for the webpage. For example, content selection service 104 may use text or image recognition on the webpage to determine that the webpage is devoted to the topical category of /Sports/Golf.

Content selection service 104 may apply one or more weightings to an interest or product category, to determine whether the category is to be associated with a device identifier. For example, content selection service 104 may impose a maximum limit to the number of product or interest categories associated with a device identifier. The top n-number of categories having the highest weightings may then be selected by content selection service 104 to be associated with a particular device identifier. A category weighting may be based on, for example, the number of webpages visited by the device identifier regarding the category, when the visits occurred, how often the topic of the category was mentioned on a visited webpage, or any online actions performed by the device identifier regarding the category. For example, topics of more recently visited webpages may receive a higher weighting than webpages that were visited further in the past. Categories may also be subdivided by the time periods in which the webpage visits occurred. For example, the interest or product categories may be subdivided into long-term, short-term, and current categories, based on when the device identifier visited a webpage regarding the category.

In some implementations, content selection service 104 may use a predictive model to associate a device identifier with a content selection parameter value. The predictive model may be based in part on known parameter values for other device identifiers. For example, assume that at least a portion of the visitors to a particular website log into accounts on the website that include information about the users. Such information may be used in a predictive model to predict the characteristics of other users that also visit the website (e.g., if the average logged in visitor to the website is male, it is likely that another visitor to the website is also male). In one implementation, the predictive model may also generate one or more precision factors associated with a predicted parameter value. For example, the model may predict that a user represented by a device identifier is male, with an 80% degree of confidence. In some cases, the model may predict multiple parameter values for a device identifier. For example, the model may predict that a user represented by a device identifier is between the ages of 24-34 with a precision of 75% and age 18+ with a precision of 98%. Thus, different groupings of overlapping content selection parameter values may result in different precision factors.

Content selection service 104 may be configured to conduct a content auction among third-party content providers to determine which third-party content is to be provided to client device 102. For example, content selection service 104 may conduct a real-time content auction in response to client device 102 requesting first-party content from one of content sources 108, 110 or executing a first-party application. Content selection service 104 may use any number of factors to determine the winner of the auction. For example, the winner of a content auction may be based in part on the third-party provider's bid and/or a quality score for the third-party provider's content (e.g., a measure of how likely the user of client device 102 is to click on the content). In other words, the highest bidder is not necessarily the winner of a content auction conducted by content selection service 104, in some implementations.

Content selection service 104 may be configured to allow third-party content providers to create campaigns or other groupings (e.g., an advertisement group) to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at client device 102. In other words, the bid amount may be on a cost per impression or cost per thousand impressions (CPM) basis. In further cases, a bid amount may correspond to a specified action being performed in response to the third-party content being presented at a client device. For example, a bid amount may be a monetary amount that the third-party content provider is willing to pay, should their content be clicked on at the client device, thereby redirecting the client device to the provider's webpage. In other words, a bid amount may be a cost per click (CPC) bid amount. In another example, the bid amount may correspond to an action being performed on the third-party provider's website, such as the user of client device 102 making a purchase. Such bids are typically referred to as being on a cost per acquisition (CPA) or cost per conversion basis.

A campaign created via content selection service 104 may also use content selection parameters that control when a bid is placed on behalf of a third-party content provider in a content auction. If the third-party content is to be presented in conjunction with search results from a search engine, for example, the selection parameters may include one or more sets of search keywords. For example, the third-party content provider may only participate in content auctions in which a search query for “golf resorts in California” is sent to a search engine. Other parameters may control when a bid is placed on behalf of a third-party content based on a topic identified using a device identifier's history data (e.g., based on webpages visited by the device identifier or other online actions), the topic of a webpage or other first-party content with which the third-party content is to be presented, a geographic location of the client device that will be presenting the content, a geographic location specified as part of a search query, or predicted user characteristics. In some cases, a selection parameter may designate a specific webpage, website, or group of websites with which the third-party content is to be presented. For example, an advertiser selling golf equipment may specify that they wish to place an advertisement on the sports page of an particular online newspaper.

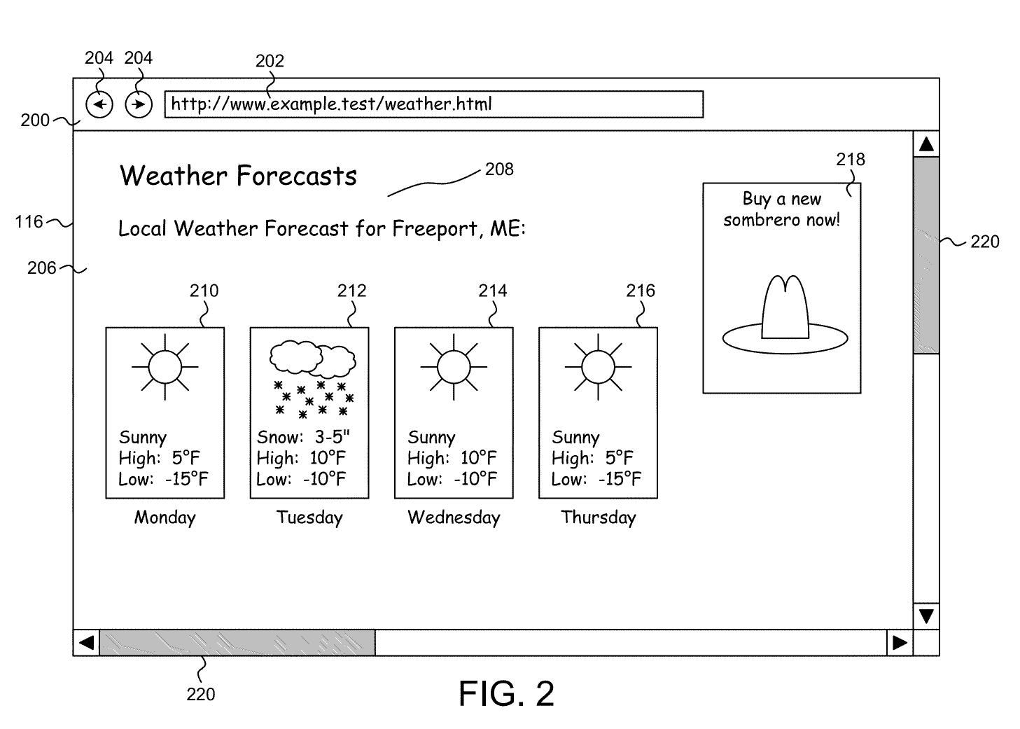

Referring now to FIG. 2, an illustration is shown of electronic display 116 displaying an example first-party webpage 206. Electronic display 116 is in electronic communication with processor 112 which causes visual indicia to be displayed on electronic display 116. As shown, processor 112 may execute a web browser 200 stored in memory 114 of client device 102, to display indicia of content received by client device 102 via network 106. In other implementations, another application executed by client device 102 may incorporate some or all of the functionality described with regard to web browser 200 (e.g., a video game, a chat application, etc.).

Web browser 200 may operate by receiving input of a uniform resource locator (URL) via a field 202 from an input device (e.g., a pointing device, a keyboard, a touch screen, etc.). Processor 112 may use the inputted URL to request data from a content source having a network address that corresponds to the entered URL. In other words, client device 102 may request first-party content accessible at the inputted URL. In response to the request, the content source may return webpage data and/or other data to client device 102. Web browser 200 may analyze the returned data and cause visual indicia to be displayed by electronic display 116 based on the data.

In general, webpage data may include text, hyperlinks, layout information, and other data that may be used to provide the framework for the visual layout of first-party webpage 206. In some implementations, webpage data may be one or more files of webpage code written in a markup language, such as the hypertext markup language (HTML), extensible HTML (XHTML), extensible markup language (XML), or any other markup language. The webpage data may include data that specifies where indicia appear on first-party webpage 206, such as text 208. In some implementations, the webpage data may also include additional URL information used by web browser 200 to retrieve additional indicia displayed on first-party webpage 206.

Web browser 200 may include a number of navigational controls associated with first-party webpage 206. For example, web browser 200 may be configured to navigate forward and backwards between webpages in response to receiving commands via inputs 204 (e.g., a back button, a forward button, etc.). Web browser 200 may also include one or more scroll bars 220, which can be used to display parts of first-party webpage 206 that are currently off-screen. For example, first-party webpage 206 may be formatted to be larger than the screen of electronic display 116. In such a case, the one or more scroll bars 220 may be used to change the vertical and/or horizontal position of first-party webpage 206 on electronic display 116.

First-party webpage 206 may be devoted to one or more topics. For example, first-party webpage 206 may be devoted to the local weather forecast for Freeport, Me. In some implementations, a content selection server, such as content selection service 104, may analyze the contents of first-party webpage 206 to identify one or more topics. For example, content selection service 104 may analyze text 208 and/or images 210-216 to identify first-party webpage 206 as being devoted to weather forecasts. In some implementations, webpage data for first-party webpage 206 may include metadata that identifies a topic.

In various implementations, content selection service 104 may select some of the content presented on first-party webpage 206 (e.g., an embedded image or video, etc.) or in conjunction with first-party webpage 206 (e.g., in a pop-up window or tab, etc.). For example, content selection service 104 may select third-party content 218 to be included on webpage 206. In some implementations, one or more content tags may be embedded into the code of webpage 206 that defines a content field located at the position of third-party content 218. Another content tag may cause web browser 200 to request additional content from content selection service 104, when first-party webpage 206 is loaded. Such a request may include one or more keywords, a device identifier for client device 102, or other data used by content selection service 104 to select content to be provided to client device 102. In response, content selection service 104 may select third-party content 218 for presentation on first-party webpage 206.

Content selection service 104 may select third-party content 218 (e.g., an advertisement) by conducting a content auction, in some implementations. Content selection service 104 may also determine which third-party content providers compete in the auction based in part on values of content selection parameters used by the providers. For example, only content providers that specified a topic that matches that of webpage 206, an interest category of a device identifier accessing webpage 206, or webpage 206 specifically may compete in the content auction. In another example, only content providers that specified a predicted user characteristic associated with the device identifier of client device 102 may participate in the auction. Based on bidding parameters for these third-party content providers, content selection service 104 may compare their bid amounts, quality scores, and/or other values to determine the winner of the auction and select third-party content 218 for presentation with webpage 206.

In some implementations, content selection service 104 may provide third-party content 218 directly to client device 102. In other implementations, content selection service 104 may send a command to client device 102 that causes client device 102 to retrieve third-party content 218. For example, the command may cause client device 102 to retrieve third-party content 218 from a local memory, if third-party content 218 is already stored in memory 114, or from a networked content source. In this way, any number of different pieces of content may be placed in the location of third-party content 218 on first-party webpage 206. In other words, one user that visits first-party webpage 206 may be presented with third-party content 218 and a second user that visits first-party webpage 206 may be presented with different content. Other forms of content (e.g., an image, text, an audio file, a video file, etc.) may be selected by content selection service 104 for display with first-party webpage 206 in a manner similar to that of third-party content 218. In further implementations, content selected by content selection service 104 may be displayed outside of first-party webpage 206. For example, content selected by content selection service 104 may be displayed in a separate window or tab of web browser 200, may be presented via another software application (e.g., a text editor, a media player, etc.), or may be downloaded to client device 102 for later use.

Third-party content 218 may be interactive content. In other words, the user of client device 102 may interact with third-party content 218 via an interface device. For example, third-party content 218 may be clickable (e.g., via a mouse, touch screen, etc.) and hotlinked to a landing webpage of the third-party content provider. In various implementations, webpage 206, third-party content 218, and/or the landing webpage may be configured to cause client device 102 to report a content interaction with third-party content 218 to content selection service 104 and/or to content source 108. In one implementation, webpage 206 and the landing webpage may include pixel tags that allows content selection service 104 to set a cookie on client device 102 and cause client device 102 to report the cookie back to content selection service 104 when the landing webpage is loaded. In another implementation, assume that client device 102 is logged into an account of content source 108 and the landing webpage includes code that cases client device 102 to report that the user of client device 102 clicked on third-party content 218 and was redirected to the hotlinked webpage of the third-party content provider. Content source 108 may then provide the recorded data to content selection service 104. Thus, content selection service 104 may receive data regarding interactions with third-party content 218 by users that are presented the content. If a user is also logged into an account with content source 108, content selection service 104 may also associate the content interaction with the account.

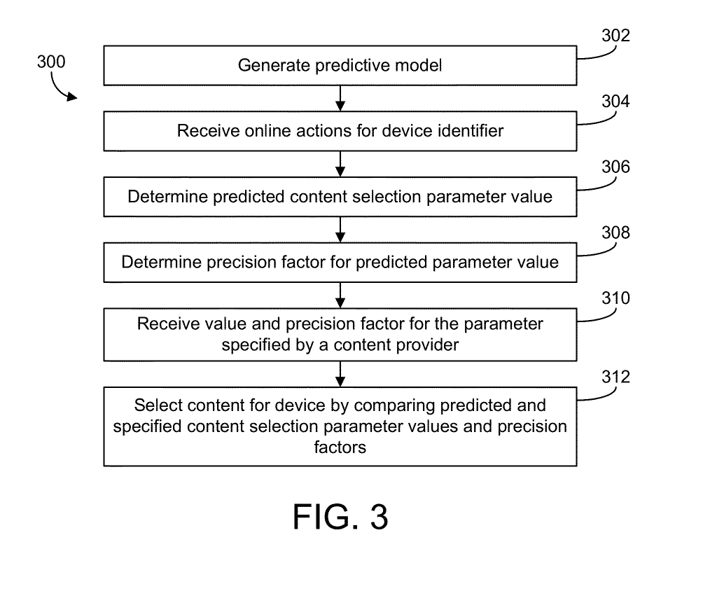

Referring now to FIG. 3, a flow diagram of the steps taken in one implementation of a process 300 for selecting content using precision controls is shown. Process 300 generally includes generating a predictive model (step 302), receiving online actions for a device identifier (step 304), determining a predicted content selection parameter value (step 306), determining a precision factor for the predicted parameter value (step 308), receiving a value and precision factor specified by a content provider (step 310), and selecting content for a device based on the predicted and specified parameter values and precision factors (step 312). Process 300 may be implemented by one or more computing devices executing stored machine instructions. For example, process 300 may be implemented by content selection service 104 shown in FIG. 1. In general, process 300 allows a third-party content provider to control which device identifiers are eligible to receive content from the provider based on a specified content selection parameter value and precision factor.

Referring still to the implementation of FIG. 3, process 300 includes generating a predictive model (step 302). The predictive model may be generated based on online actions of device identifiers for which content selection parameter values are known. Online actions may be any form of action performed by a device relative to online content (e.g., visiting a website, clicking on certain content, playing a certain media file, purchasing a particular good or service, etc.). In some cases, the known content selection parameter values may be retrieved from user profiles or accounts associated with the online actions. For example, some users may provide information about themselves as part of an account used to access a certain website. To protect the identities of these users, the users may be represented by device identifiers that contain no personally-identifiable information. In further cases, the known content selection parameter values may be reported in the aggregate by the first-party content provider to the content selection service. For example, a first-party content provider operating a website may report aggregated statistics regarding visitors to the provider's website to the content selection service.

Based on the known parameter values and their associated online actions, the predictive model may predict one or more content selection parameter values for a device identifier using online actions associated with the device identifier. For example, based on a device identifier visiting a particular set of websites, the predictive model may predict one or more content selection parameter values. In some cases, multiple ‘buckets’ may be used by the predictive model for the selection parameter values such as ranges of values. The predictive model may also determine a precision factor associated with any content selection parameter value predicted for a device identifier. In general, a precision factor represents a degree of confidence in the predicted selection parameter value. For example, if 51% of the visitors to a particular website have a known parameter value and 49% of the visitors have a different value, another visitor to the website may be predicted to have the first parameter value with a low degree of confidence. However, if 95% of the visitors have the first parameter value, another visitor to the website may be predicted to also have this value with a higher degree of confidence.

Referring still to the implementation of FIG. 3, process 300 includes receiving data indicative of online actions for a device identifier (step 304). The device identifier may be any form of identifier used to identify a device to the content selection service such as a cookie, a unique device identifier (UDID), a hardware and/or software based serial, or the like. Data indicative of online actions performed by the device identifier may include, but are not limited to, visiting a particular webpage or website, interacting with certain third-party content (e.g., clicking on an advertisement), playing certain media content, making an online purchase, downloading certain software, signing up for a contact list or online service, or the like.

Referring still to the implementation of FIG. 3, process 300 includes determining a predicted content selection parameter value for the device identifier (step 306). Using the online actions associated with the device identifier as inputs to the predictive model, one or more content selection parameter values may be predicted by the model for the device identifier. For example, the model may analyze the webpage visits, played content, etc. of the device identifier to predict one or more content selection parameter values for the device identifier. In some cases, multiple overlapping content selection parameter values may be predicted, such as ranges of values that overlap.

Referring still to the implementation of FIG. 3, process 300 includes determining a precision factor for the one or more content selection parameter values predicted for the device identifier (step 308). A precision factor may be generated by the predictive model for some or all of the parameter values predicted for the device identifier. In general, the precision factor represents the probability that the predicted content selection parameter value is accurate. For example, one predicted parameter value for the device identifier may have a precision factor of 75% while another predicted parameter value may have a precision factor of 95%.

Referring yet still to the implementation of FIG. 3, process 300 includes receiving a content selection parameter value and a precision factor specified by a third-party content provider (step 310). The specified parameter value and precision factor may be associated with a particular piece of third-party content, a grouping of third-party content (e.g., an ad group), a campaign, etc. or may be set on a global level for a provider's account with the content selection service. A specified precision factor may be required for certain content selection parameters or may be optionally specified by a content provider. For example, a third-party content provider may specify that a certain advertisement is to be presented only to device identifiers having the specified parameter value, as predicted by the selection service, and with a precision factor equal to or greater than the precision factor specified by the provider.

Referring still to the implementation of FIG. 3, process 300 includes selecting content for a device by comparing the predicted and specified content selection parameters and precision factors (step 312). If the content selection parameter value predicted for the device identifier in step 306 matches the content selection parameter value specified by the third-party content provider, the device identifier may generally be eligible to receive content from the provider. If a precision factor has also been specified by the provider, the predicted factor for the device identifier may be compared to the precision factor specified by the provider to determine whether the identifier is actually eligible to receive the content. In some cases, the content selection service may still apply a minimum precision factor threshold on behalf of a content provider that does not explicitly specify a precision factor.

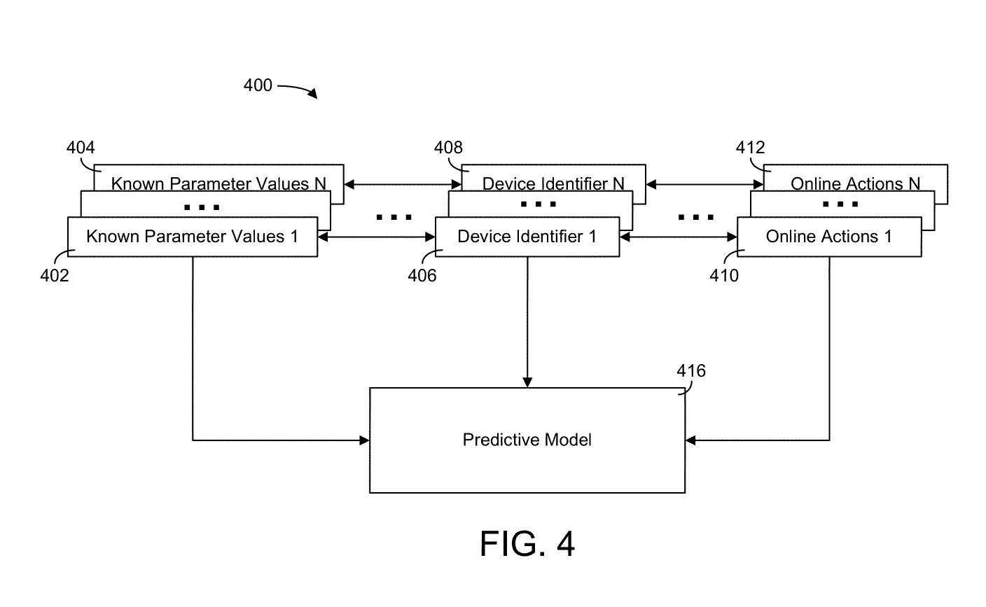

Referring now to FIG. 4, an illustration 400 is shown of one implementation of a model generated to predict content selection parameters. As shown, various data may be used to generate a predictive model 416 configured to predict one or more content selection parameter values for a device identifier. In one implementation, known parameter values 402-404 (e.g., a set of a first through nth parameter values) may be associated with any number of device identifiers 406-408. Known parameter values 402-404 may be based on information provided via accounts or online profiles, answers to online surveys (e.g., a visitor to a given webpage may be asked to complete a short survey), or any other data self-reported by the users corresponding to device identifiers 406-408. Known parameter values 402-404 may also be associated with online actions 410-412, such as visits to a particular webpage or website, watching a particular video, making an online purchase, or any other form on online action. In some cases, predictive model 416 may be generated using data provided by a first-party content provider to the content selection service. Predictive model 416 may also be generated without use of device identifiers 406-408, such as using reported data from a first-party content provider.

Known parameter values 402-404 and online actions 410-412 may be from any time period and/or any number of different sources. For example, predictive model 416 may be generated using the most current, short-term (e.g., within the last several hours, within the last day, etc.) or long-term (e.g., within the prior thirty days, etc.) online actions 410-412. In another example, predictive model 416 may use data directly observed by the content selection service or data received from a first-party content provider regarding consumers of the first-party content. In some implementations, online actions 410-412 may include data indicative of the content accessed by device identifiers 406-408 such as features of the content. Content features may be the domain of a visited webpage, word clusters or other groupings of words that appear on a visited webpage, or the like. For example, a particular grouping of words that appear on a visited website associated with known parameter values 402-404 may be used by predictive model 416 to predict parameter values for visitors to another website that uses the same grouping of words.

Any form of machine learning or statistical technique may be used to generate predictive model 416. In one implementation, predictive model 416 may be a logistic regression model that is trained using known parameter values 402-404 and online actions 410-412. Other forms of models may include, but are not limited to, Bayesian models, neural networks, statistical models using confidence intervals, and the like.

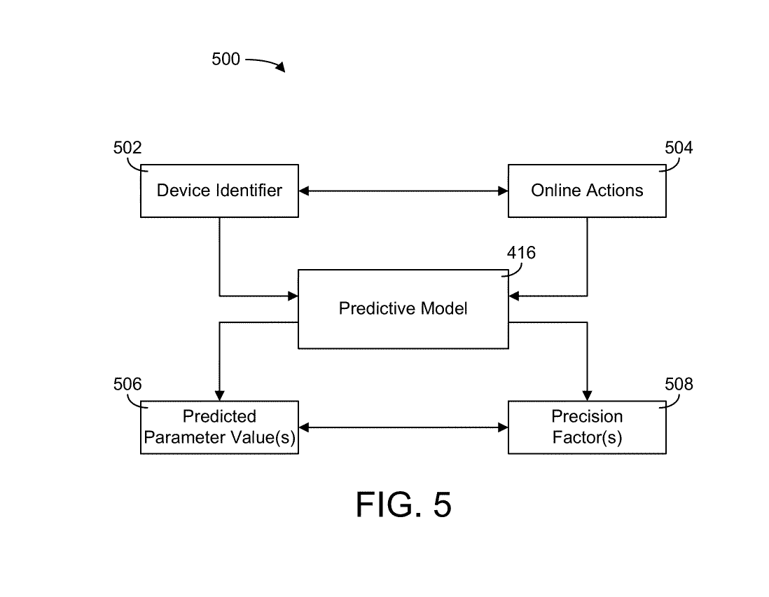

Referring now to FIG. 5, an illustration 500 is shown of the predictive model 416 of FIG. 4 used to predict content selection parameters for a device identifier 502. As shown, online actions 504 associated with device identifier 502 may be used as input to predictive model 416 to determine one or more predicted parameter values 506. Predicted parameter values 506 may be any set of values for a parameter used by the content selection service to determine whether device identifier 502 is eligible to receive a particular piece of third-party content. In one implementation, predicted parameter values 506 may be consecutive or overlapping ranges of values. For example, predicted parameter values 506 may correspond to males aged 18+, males 18-34, etc. Any number of ranges or combinations of values may be included in predicted parameter values 506.

In one implementation, predictive model 416 may also generate precision factors 508 associated with the predicted parameter values 506. In general, precision factors 508 represent the likelihood that each of predicted parameter values 506 accurately predict the parameter values for device identifier 502. For example, if a device identifier is associated with a particular parameter value with a precision of 85%, there is an 85% chance that the predicted value is correct.

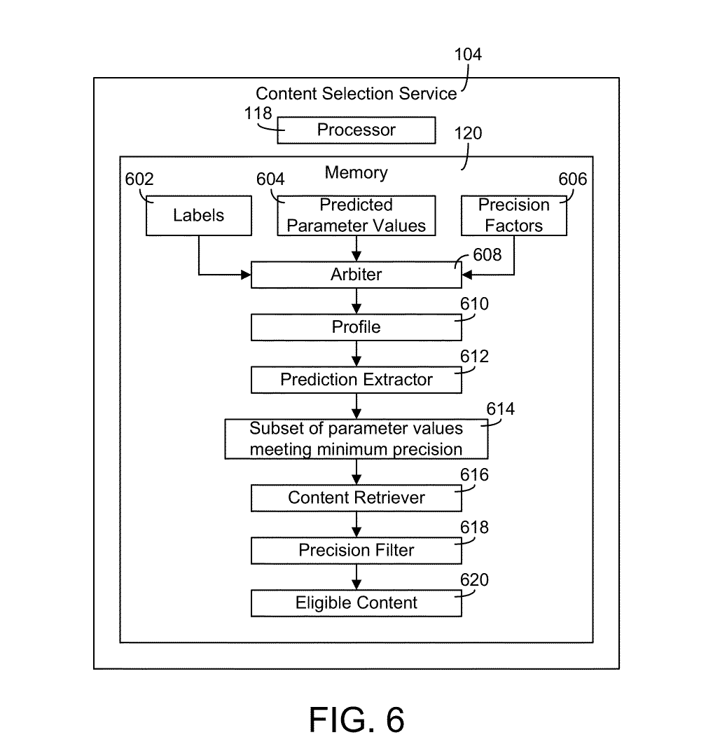

Referring now to FIG. 6, a block diagram is shown of one implementation of the content selection service of FIG. 1. In the implementation shown, memory 120 of content selection service 104 may store data and instructions that, when executed by processor 118, cause content selection service 104 to allow precision controls to be used with content selection parameters. For example, a third-party content provider may specify a desired level of precision for a specified content selection parameter value used by content selection service 104 to control which device identifiers are eligible to receive content from the provider.

Memory 120 may include labels 602 associated with a device identifier. Labels 602 may be flags, data values, or the like that override the use of predicted parameter values 604 for the device identifier. In some cases, labels 602 may disable a particular content selection parameter from being used relative to the device identifier. For example, an opt-out parameter value in labels 602 may prevent content selection service 104 from using certain selection parameters to select content for the device identifier. Labels 602 may also include opt-in data, such as content selection parameter values that are explicitly specified by a user. For example, a user may be given the opportunity to provide information about himself or herself to content selection service 104, so that relevant content can be selected for presentation to the user.

Predicted parameter values 604 in memory 120 may be any content selection values generated by one or more predictive models for the device identifier. In some cases, different predictive models may be used on different sets of data to generate parameter values 604. For example, one model may use a long-term history of online actions associated with the device identifier to generate parameter values 604 while another model may use a short-term history. Predicted parameter values 604 may also include previously predicted values for the device identifier, such as the last n-number of values predicted using short-term history data. In a further example, predicted parameter values 604 may be generated by a document-based predictive model that analyzes the content of the current webpage visited by a device identifier to predict the parameter values. Some of predicted parameter values 604 may also be received from other sources, such as from a first-party content provider, a social networking service, a media sharing service, or the like. The models used to predict parameter values 604 may use offline data (e.g., as part of a periodic batch job) and/or online data (e.g., based on the user's current actions) to generate parameter values 604. Associated with predicted parameter values 604 may be precision factors 606 that represent the likelihood that predicted parameter values 604 is correct.

Memory 120 may include an arbiter 608 configured to generate a profile 610 for the device identifier. Profile 610 may be an aggregation of content selection parameter values predicted for the device identifier. In one implementation, arbiter 608 may use labels 602, if they exist, to define the selection parameter values in profile 610. For example, arbiter 608 may use a demographic specified explicitly by a user on an opt-in basis over any of predicted parameter values 604. If a label is not associated with the device identifier for a particular content selection parameter, arbiter 608 may apply weightings to the different predicted parameter values 604. For example, arbiter 608 may give a higher weighting to a parameter value predicted using long-term data than a value predicted using short-term data. Using the weightings, arbiter 608 may determine the finalized selection parameter values and corresponding precision factors for inclusion in profile 610. In a further implementation, arbiter 608 may be configured to verify whether a user-specified parameter value is correct by comparing the user-specified parameter value to the weighted parameter values predicted by the system. For example, assume that a user explicitly specifies a value for a content selection parameter, but that some or all of the predicted values regarding the user contradict the user-specified value with a high degree of precision. In such a case, arbiter 608 may instead use one of the predicted values instead of the user-specified value since the user-specified value may be erroneous (e.g., users share the same device identifier, a user accidentally specifies the wrong value, etc.).

In some implementations, memory 120 includes a prediction extractor 612 configured to determine a subset 614 of parameter values. Prediction extractor 612 may apply one or more minimum thresholds to the precision factors in profile 610 to determine which parameter values are to be included in subset 614. For example, prediction extractor 612 may include only those content selection parameter values in profile 610 having a corresponding precision factor of 60% or greater. In one implementation, prediction extractor 612 is configured to determine the narrowest range of parameter values for inclusion in subset 614 that satisfy the minimum threshold. For example, if the age ranges of 18-44 and 18-34 both have precision factors satisfying the minimum threshold, prediction extractor 612 may include the age range of 18-34 in subset 614 because it has a narrower range than that of 18-44. The minimum precision threshold used by prediction extractor 612 may be imposed globally by content selection service 104, may be specific to a certain content selection parameter, or may be varied in any other way.

Memory 120 may include a content retriever 616 configured to retrieve third-party content based on the content selection parameter values in subset 614. For example, assume subset 614 includes parameter values corresponding to the age group of 18+ with a precision factor of 95% and to the age group of 24-34 with a precision factor of 80%. Since both selection parameter values have precision factors over a minimum threshold (e.g., as determined by prediction extractor), these values may be used by content retriever 616 to identify third-party content with which the 18+ and/or 24-34 year old age group are associated. In other words, third-party content associated with the age group of 52-64 may be excluded by content retriever 616 if this group is not included in subset 614. By first identifying third-party content having content selection parameter values in subset 614, all third-party content potentially eligible for selection can be evaluated.

Memory 120 may include a precision filter 618 configured to apply precision factors specified by third-party content providers to the results generated by content retriever 616. For example, assume that a third-party content provider specifies that an advertisement is to be sent based on a particular content selection parameter value with a precision of 95% and that the corresponding parameter value in subset 614 only has a precision of 85%. In such a case, content retriever 616 may initially identify the third-party content from the provider as potentially eligible for selection. However, since the provider has specified a higher degree of precision than what is predicted for the device identifier, the provider's content may be excluded from selection for the device identifier. In one implementation, any third-party content for which a precision factor is not specified may be included in eligible content 620 by precision filter 618. Likewise, any third-party content having a specified precision greater than or equal to the precision in subset 614 for the device identifier may be included in eligible content 620. Thus, eligible content 620 may include only those pieces of third-party content from providers that use a content selection parameter value in the profile of the device identifier and with a level of precision acceptable to the providers.

Content selection service 104 may select third-party content for presentation to the device from among eligible content 620 in any number of ways. In some cases, content selection service 104 may conduct an auction among the corresponding third-party content providers to determine which content in eligible content 620 is actually selected for presentation to the device identifier. Such an auction may be based on bids placed by the content providers, one or more quality scores associated with the content (e.g., how likely a user is to click on the third-party content, etc.), or combinations thereof.

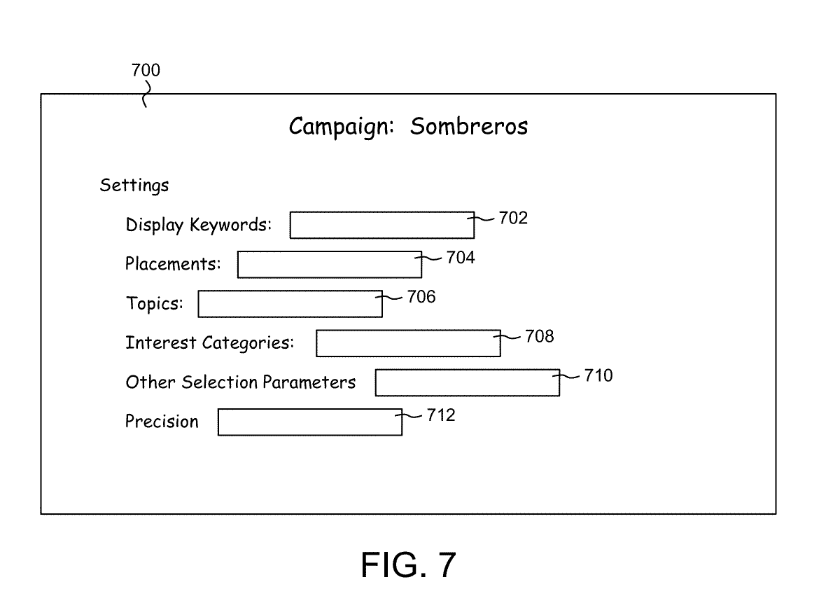

Referring now to FIG. 7, an illustration of one implementation of an interface 700 configured to allow a third-party content provider to specify content selection parameters with precision controls is shown. In the implementation shown, assume that a third-party content provider is an online retailer that sells hats. Interface 700 may be part of a configuration interface that allows the retailer to set up an advertising campaign and to use content selection parameters with the campaign. Based on the specified values of the content selection parameters, the content selection service may determine whether or not the provider's content is eligible for presentation to certain device identifiers.

Interface 700 may include any number of inputs 702-712 configured to receive specified content selection parameter values. Input 702 may receive one or more sets of display keywords. If any display keywords are specified, the third-party content associated with the campaign may only be eligible for presentation on websites that use the specified keywords. For example, if the content providers specifies the keywords “automobile insurance,” the provider's advertisement will only be eligible for presentation on websites that use the same or similar keywords. Input 704 may receive one or more placement values that denote specific websites, webpages, etc. on which the third-party content is eligible for presentation. For example, input 704 may be used in the campaign to limit the appearance of advertisements to a specific first-party website. Input 706 may receive topical categories of first-party content. If any such categories are specified, the content selection service may limit the presentation of the third-party content to first-party content having a matching topic. Input 708 may receive one or more specified interest categories. If a particular device identifier is associated with a matching interest category, it may be eligible to receive the provider's content. For example, an advertiser may specify that he or she only wishes to send advertisements to users that are interested in golf.

Input 710 may receive any other specified content selection parameter value and input 712 may receive a desired level of precision for the value. For example, only device identifiers having a predicted selection value matching the value specified in input 710 may receive the content associated with the campaign. Similarly, only those device identifiers having the predicted value with a precision equal or greater than the precision factor specified in input 712 may be eligible to receive the provider's content. For example, if the provider specifies a degree of precision of 95% via input 712, only those device identifiers having the selection parameter value in input 710 predicted with a level of precision of 95% or greater may potentially receive the provider's content.

In further implementations, input 712 may be a slider bar or any other form of graphical input mechanism. For example, interface 700 may include a chart that shows the tradeoff of coverage vs. precision for different values of a content selection parameter. In such a case, input 712 may correspond to a slider bar that allows the operator of interface 700 to select the degree of precision desired for a given content selection parameter value. In another implementation, interface 700 may include an input that allows a third-party content provider to specify how much money he or she is willing to spend each time the correct user is exposed to the provider's content. Based on the received amount, the system may translate the received amount into an appropriate degree of precision on behalf of the content provider.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top boxor other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

1. A method of selecting content for presentation by a device, comprising:
generating, by one or more processors, a predictive model that estimates values of a content selection parameter based on online actions associated with a set of device identifiers;
receiving, by the one or more processors, data indicative of online actions associated with a device identifier representing the device;
determining, by the one or more processors, a predicted value of the content selection parameter for the device identifier using the predictive model and the data indicative of online actions associated with the device identifier;
determining, by the one or more processors, a precision factor associated with the predicted value of the content selection parameter for the device identifier;
receiving a specified value and a specified degree of precision for the content selection parameter that are specified by a content provider;
performing a first comparison between the predicted value of the content selection parameter for the device identifier and the specified value for the content selection parameter specified by the content provider;
determining a match between the predicted value of the content selection parameter for the device identifier and the specified value for the content selection parameter as a result of the first comparison;
responsive to the match between the predicted value and the specified value, performing a second comparison between the precision factor associated with the predicted value of the content selection parameter for the device identifier and the specified degree of precision for the content selection parameter specified by the content provider;
determining, as a result of the second comparison, that the precision factor associated with the predicted value satisfies the specified degree of precision; and
selecting content of the content provider for presentation by the device responsive to the result of the second comparison.

2. The method of claim 1, wherein generating the predictive model comprises:
analyzing account data for the set of device identifiers to determine values for the content selection parameter.

3. The method of claim 2, further comprising:
using the values for the content selection parameter to represent different characteristic ranges.

4. The method of claim 3, further comprising:
associating different precision factors with the different characteristic ranges for the device identifier, wherein the predicted value of the content selection parameter for the device identifier corresponds to the characteristic range having the highest associated precision factor.

5. The method of claim 1, wherein determining a predicted value of the content selection parameter for the device identifier comprises:
determining a predicted characteristic associated with the device identifier.

6. The method of claim 1, further comprising:
applying a global threshold precision factor to the predicted value of the content selection parameter for the device identifier to generate a subset of content selection parameter values for the device identifier; and
identifying third-party content eligible for selection based on the subset of content selection parameter values for the device identifier.

7. The method of claim 3, further comprising:
using the values for the content selection parameter to represent different combinations of characteristics.

8. A system for selecting content for presentation by a device comprising one or more processors configured to:
generate a predictive model that estimates values of a content selection parameter based on online actions associated with a set of device identifiers;
receive data indicative of online actions associated with a device identifier representing the device;
determine a predicted value of the content selection parameter for the device identifier using the predictive model and the data indicative of online actions associated with the device identifier;
determine a precision factor associated with the predicted value of the content selection parameter for the device identifier;
receive a specified value and a specified degree of precision for the content selection parameter that are specified by a content provider;
perform a first comparison between the predicted value of the content selection parameter for the device identifier and the specified value for the content selection parameter specified by the content provider;
determine a match between the predicted value of the content selection parameter for the device identifier and the specified value for the content selection parameter as a result of the first comparison;
perform, responsive to the match between the determined predicted value and the specified value, a second comparison between the precision factor associated with the predicted value of the content selection parameter for the device identifier and the specified degree of precision for the content selection parameter specified by the content provider;
determine, as a result of the second comparison, that the precision factor associated with the predicted value satisfies the specified degree of precision; and
select content of the content provider for presentation by the device responsive to the result of the second comparison.

9. The system of claim 8, wherein the predictive model is generated by analyzing account data for the set of device identifiers to determine values for the content selection parameter.

10. The system of claim 9, wherein the one or more processors are configured to use the values for the content selection parameter to represent different characteristic ranges.

11. The system of claim 10, wherein the one or more processors are configured to associate different precision factors with the different characteristic ranges for the device identifier, wherein the predicted value of the content selection parameter for the device identifier corresponds to the characteristic range having the highest associated precision factor.

12. The system of claim 8, wherein a predicted value of the content selection parameter for the device identifier is determined by determining a predicted characteristic associated with the device identifier.

13. The system of claim 8, wherein the one or more processors are configured to:
apply a global threshold precision factor to the predicted value of the content selection parameter for the device identifier to generate a subset of content selection parameter values for the device identifier; and
identify third-party content eligible for selection based on the subset of content selection parameter values for the device identifier.

14. The system of claim 8, wherein the one or more processors are configured to determine the accuracy of a user-specified value of the content selection parameter.

15. A non-transitory computer-readable storage medium having machine instructions stored therein, the instructions being executable by one or more processors to cause the one or more processors to perform operations comprising:
generating a predictive model that estimates values of a content selection parameter based on online actions associated with a set of device identifiers;
receiving data indicative of online actions associated with a device identifier representing the device;
determining a predicted value of the content selection parameter for the device identifier using the predictive model and the data indicative of online actions associated with the device identifier;
determining a precision factor associated with the predicted value of the content selection parameter for the device identifier;
receiving a specified value and a specified degree of precision for the content selection parameter that are specified by a content provider;
performing a first comparison between the predicted value of the content selection parameter for the device identifier and the specified value for the content selection parameter specified by the content provider;
determining a match between the predicted value of the content selection parameter for the device identifier and the specified value for the content selection parameter as a result of the first comparison;
responsive to the match between the predicted value and the specified value, performing a second comparison between the precision factor associated with the predicted value of the content selection parameter for the device identifier and the specified degree of precision for the content selection parameter specified by the content provider;
determining, as a result of the second comparison, that the precision factor associated with the predicted value satisfies the specified degree of precision; and
selecting content of the content provider for presentation by the device responsive to the result of the second comparison.

16. The non-transitory computer-readable storage medium of claim 15, wherein the predictive model is generated by analyzing account data for the set of device identifiers to determine values for the content selection parameter.

17. The non-transitory computer-readable storage medium of claim 16, wherein the operations comprise:
using the values for the content selection parameter to represent different characteristic ranges.

18. The non-transitory computer-readable storage medium of claim 17, wherein the operations comprise:
associating different precision factors with the different characteristic ranges for the device identifier, wherein the predicted value of the content selection parameter for the device identifier corresponds to the characteristic range having the highest associated precision factor.

19. The non-transitory computer-readable storage medium of claim 15, wherein a predicted value of the content selection parameter for the device identifier is determined by determining a predicted characteristic associated with the device identifier.

20. The non-transitory computer-readable storage medium of claim 15, wherein the operations comprise:
applying a global threshold precision factor to the predicted value of the content selection parameter for the device identifier to generate a subset of content selection parameter values for the device identifier; and
identifying third-party content eligible for selection based on the subset of content selection parameter values for the device identifier.
